(19) United States
(12) Patent Application Publication
(10) Pub. No.: US 2014/0297377 A1
(43) Pub. Date: Oct. 2, 2014

(54) Systems And Methods For Dynamically Generating Digital Advertisements

(71) Applicant: RETAILIGENCE CORPORATION, Redwood City, CA (US)

(72) Inventors: Shailesh Bhat, San Jose, CA (US); David Mathew Cocca, Cambridge (CA); Uday Eyunni, Sunnyvale, CA (US)

(73) Assignee: Retailigence Corporation, Redwood City, CA (US)

(21) Appl. No.: 13/855,588

(22) Filed: Apr. 2, 2013

(51) Int. Cl. G06Q 30/02

(52) U.S. Cl. CPC G06Q 30/0276
USPC 705/14.5; 705/14.66; 705/14.58

(57) ABSTRACT

Advertising systems and related methods provide dynamic generation of digital advertisements over computer networks in response to ad requests associated with available ad impressions. The system dynamically generates ad based on user information associated with ad requests and product inventory information associated with advertising campaigns. The product inventory information and advertising campaigns can be associated with one or more product suppliers. The system dynamically generates the advertisement using the user information associated with the ad request, and the product inventory information. The system dynamically generates an ad with store location information based on user location information and product inventory information in one example.

### BACKGROUND OF THE INVENTION

1. Field of the Invention

Embodiments in accordance with the present disclosure relate to computer networks, and particularly to digital advertising over computer networks.

2. Description of the Related Art

The proliferation of computer networks, particularly the Internet and World Wide Web (WWW), has led to increasing amounts of content and resources that are delivered to users via computing devices. Traditional desktop computers, televisions, set top boxes, and mobile devices represent only a portion of the devices modern consumers use to receive network-based content. With the increase in content being delivered over networks, it has only been natural that there has been a commensurate increase in the amount of advertising delivered over computer networks. Advertisements may be displayed as elements of web pages, banners on mobile and other device applications, as interstitial layers or web pages, and in numerous other ways.

Because of the different ways in which content is delivered and consumed over computer networks, a large volume of advertisements is often required. For example, different advertisements for different products offered by a single retailer may be generated so that each of the different products can be advertised. The creation of numerous ads requires a large number of resources and often many hours of human effort. Accordingly, there exists a need for improvements in digital advertising over computer networks.

### SUMMARY

Advertising systems and related methods are disclosed that provide dynamic generation of digital advertisements in response to ad requests associated with available advertising impressions. In response to a request for an advertisement, the system dynamically generates an ad based on user information associated with the ad request and product inventory information associated with an advertising campaign. The product inventory information and advertising campaign can be associated with one or more product suppliers. The system dynamically generates the advertisement using the user information associated with the ad request, and the product inventory information. In one embodiment, the system dynamically generates an ad with store location information based on user location information and product inventory information. For example, the system can determine a product associated with an advertising campaign and determine a store location with an available inventory of the product that is near or nearest to the user location.

One embodiment includes a system or process for serving digital advertisements that comprises receiving over one or more computer networks a plurality of ad requests. For each ad request, product inventory information is determined based on user information associated with the ad request. At least one ad generation template is modified to generate a digital advertisement for each ad request. The digital advertisement for each ad request includes product inventory information based on the user information associated with the ad request.

One embodiment includes a process for serving digital advertisements that comprises storing a plurality of digital advertising campaigns. Each digital advertising campaign includes an ad generation template and a campaign definition. Each ad generation template includes at least one dynamically modifiable field. The process includes receiving a plurality of advertisement requests associated with the plurality of digital ad campaigns and accessing user information associated with each advertisement request. The process includes determining product inventory information in response to each advertisement request based on the user information for the advertisement request. A digital advertisement for each advertisement request is generated by modifying the at least one dynamically modifiable field of the ad generation template for the corresponding digital campaign based on the product inventory information determined for the advertisement request.

An advertising system is provided in one embodiment that comprises one or more first storage devices that store product inventory information for a plurality of product suppliers. Each product supplier is associated with a plurality of store locations and the information for each product supplier includes product information and availability information for a plurality of products at the plurality of store locations. The system includes one or more first processors in communication with the one or more first storage devices that receive a plurality of requests for product inventory information and based on user information for each request, generate a response with product inventory information. The system includes one or more second storage devices that store a plurality of advertising campaigns. Each advertising campaign is associated with at least one ad generation template having one or more dynamic fields for replacement to generate digital advertisements. The system includes one or more second processors in communication with the one or more second storage devices that receive a plurality of ad requests including user information associated with each ad request. For each ad request the one or more second processors determine an ad campaign and generate a request to the one or more first processors for product inventory information associated with the ad campaign based on the user information of the ad request. The one or more second processors receive a response from the one or more first processors for each request and dynamically generate a digital advertisement for the request by replacing dynamically modifiable fields in the template for the corresponding advertising campaign based on the product inventory information.

### BRIEF DESCRIPTION OF THE DRAWINGS

FIG. 1 is a block diagram depicting a computer network-based advertising system according to an embodiment.

FIG. 2 is a flowchart that describes processing by an advertising platform to dynamically generate a digital advertisement in response to a particular ad request in an embodiment.

FIG. 3 is a flowchart that describes processing by a product inventory platform to generate product inventory information for use in the dynamic generation of digital advertisements in an embodiment.

FIG. 4 is a block diagram depicting a digital advertising campaign maintained by the advertising platform in an embodiment.

FIG. 5 is a block diagram depicting a digital ad generation template according to an embodiment.

FIG. 6 is a block diagram depicting a digital advertisement as generated by an ad generation template according to an embodiment.

FIG. 7 is a simplified block diagram of a computing device that can be used to implement various embodiments of the disclosed technology.

### DETAILED DESCRIPTION

Advertising systems and related methods are disclosed that provide dynamic generation of advertisements in response to indications of available ad impressions. A digital advertisement is created for each ad request from a publisher, enabling targeted delivery of relevant and up-to-date content in each digital ad. In one embodiment, the advertising system responds to each request for an ad by accessing an advertising campaign and one or more ad generation templates associated with the advertising campaign. One or more products associated with the advertising campaign are determined, either dynamically or as established by the advertising campaign. Product inventory information for the one or more products is accessed and a subset of the product inventory information is selected based on the user information. The system modifies at least a portion of the ad generation template for the advertising campaign based on the subset of the product inventory information, generating a digital advertisement dynamically in response to the advertisement request and based on user information associated with the ad request.

In one embodiment, the system maintains product inventory information that is used in the dynamic ad generation process. In one example, product inventory information is maintained for a plurality of products. The product inventory information is provided by and/or organized according to a plurality of product suppliers such as retailers, distributors, or manufacturers.

In one embodiment, the system maintains a plurality of digital advertising campaigns. Each advertising campaign is associated with one or more ad generation templates having one or more dynamic elements that are replaced in response to each ad request to generate a digital advertisement for the ad request. For each ad request, the system modifies the dynamic portions of the ad generation template based on user information and product inventory information for the ad request. The system determines a product associated with the advertising campaign. The system then determines product inventory information for the product based on the user information. For example, the system may determine one or more store locations with an available inventory of the product and compare a distance of the user from the locations based on user location information and location information for the one or more store locations. One or more store locations near or nearest to the user location can be determined with an available inventory of the product. The system can modify the dynamic portion of the ad generation template based on the product inventory information. For example, the system can indicate the location information for the one or more store locations or product information for the product (e.g., price) at the one or more locations.

In one embodiment, the system dynamically determines a product for an ad request, and generates a digital advertisement based on the dynamically determined product. By way of example, an ad generation template may include one or more dynamic fields that are populated with product information. In response to an ad request associated with an advertising campaign, the system can dynamically select a product to feature in the ad, determine product inventory information for the product, and generate an advertisement by modifying the ad generation template with product inventory information determined for the product. By way of example and not limitation, the system can select a product based on weather, product inventory, time of day, season, user information, store location, etc.

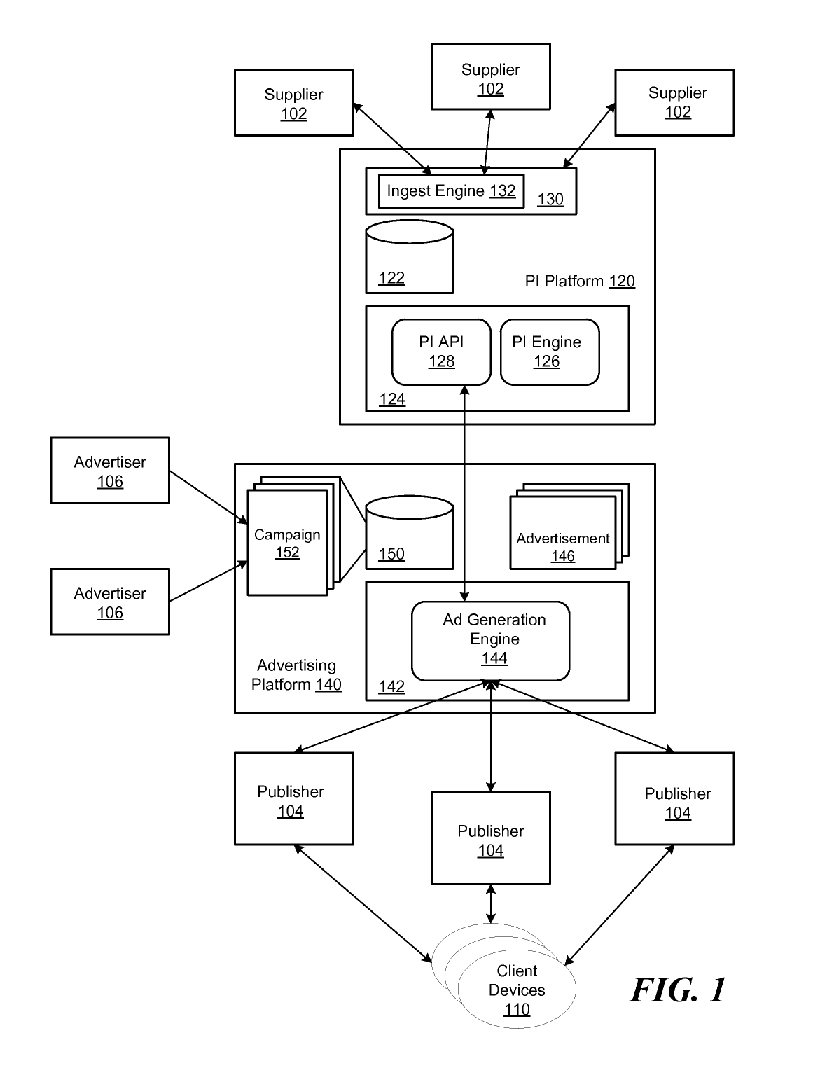

FIG. 1 is a block diagram including a computer network in which embodiments of the disclosure can be implemented. In FIG. 1, a product inventory (PI) platform 120 and an advertising platform 140 are in communication over one or more computer networks to provide an advertising system with dynamic advertisement generation based on product inventory information.

The advertising platform receives ad requests, also referred to as notices of available ad impressions, from one or more publishers 104 serving advertisements to client devices 110. The advertising platform 140 can also receive ad requests directly from client devices 110. Publishers 104 can include publishers of websites and applications, for example. Generally, publishers include any provider of content or service to client devices 110 that is interested in providing digital advertisements in association with their content. Ad networks may connect advertisers to publishers, typically managing large inventories of advertisements from many advertisers for delivery to client devices. Generally, ad networks purchase advertisements to manage an inventory of advertisements and available ad impressions, submitting ad requests to advertising platform 140 for available ad impressions. Similarly, publishers can be reached through demand-side platforms (DSP) that manage and provide an exchange for digital advertisements, allowing advertisers or other purchasers of digital advertisements to manage bids for available ad impressions in real-time. Any number of ad networks or demand-side platforms may interface between the advertising platform and publishers.

Advertising platform 140 includes one or more application servers 142 and one or more databases 150. The application servers 142 implement one or more ad generation engines 144 that manage advertising campaigns 152 on behalf of one or more advertisers 106. Advertisers 106 may include any type of product or service supplier, such as retailers, distributors, and manufacturers, for example. An advertiser may also be a product supplier 102, but this is not required. The ad generation engine receives ad requests from the various publishers for an available ad impression at a client device. In response to each ad request from a publisher, the ad generation engine 144 dynamically generates a digital advertisement 146 for delivery to the corresponding client devices 110 as part of a corresponding advertising campaign 152.

Product inventory (PI) platform 120 manages product inventory information for product suppliers 102 and provides an interface for the advertising platform to use the product inventory information in dynamic ad generation. PI platform 120 includes one or more ingest engines 132 implemented on one or more application servers 130. The ingest engines interface with suppliers 102 to receive inventory information associated with the retailer. The ingest engine may receive the information in various formats. For example, a retailer or brand owner may periodically upload or otherwise transfer (e.g., by FTP) one or more files containing inventory information to database 122 or another storage device. In other example, the ingest engine may provide an application programming interface (API) that accesses real-time inventory information provided by suppliers 102. The ingest engine processes the information from suppliers 102 to generate supplier records in database 122.

Product inventory information typically includes product information, store location information, and product availability information but need not include each type of information and may include additional information. In one embodiment, the PI platform maintains data organized by supplier, such as by retailer, distributor or manufacturer. The PI platform maintains the organized data in supplier records in one or more databases 122. For a product supplier, the product inventory information can indicate one or more locations such as retail locations associated with a retail supplier. For each location, the product inventory information includes location information, product information, and product availability information. The location information includes a physical address of the store location. The product information provides information for one or more of the plurality of products provided at the location. The product availability information indicates the availability of each of the one or more products, for example indicating whether or not the product is in-stock or a number of available in-stock items.

Each ad request that is received at the advertising platform 140 is associated with a particular ad impression that is available at a client device 110. In response to each ad request, the ad generation engine 144 accesses user information associated with the ad request. For example, an ad request can contain information about the available ad impression, such as information about the user associated with a client device 110 or the client device itself, collectively referred to as user information. The type or amount of user information included in an ad request may vary based on what information is available to the publisher submitting the ad request. In one example, an ad request includes a current location associated with the user of a client device 110. The location may be identified by longitude and latitude, zip code, city or any number of means. User information with an ad request may also include user profile information such as gender, age, interests, etc. User information may also include information about the user's network connection, including IP address, connection type, device type, browser type, and/or application associated with the ad request.

The ad generation engine passes a portion of the user information, and optionally campaign information, with a request for product inventory information to the PI API. The PI API accesses the user information and campaign information to determine product inventory information from database 122. For example, the PI API may determine product information for a product associated with the campaign and location information for a store where the product is available based on product inventory information. The PI API can use user location information associated with the ad request to narrow the location information that is returned. After determining product inventory information, the PI API returns the information to the ad generation 144.

Ad generation engine 144 uses the product inventory information returned by the PI API to dynamically generate an advertisement based on a corresponding campaign. The ad generation engine accesses an ad generation template associated with the campaign in one embodiment. The product inventory information is used to modify the ad generation template for the particular ad request. The ad generation engine thus generates the advertisement 146 in response to the ad request based on user information associated with the ad request and product inventory information associated with the advertising campaign.

The servers, client devices and other components of the system may communicate using any combination of local area networks, wide area networks (WAN), the Internet, and/or any other network. Networks typically include at least one public network such as the Internet with the various components communicating using well know communication protocols such as HTTP, HTTPs, etc. The various request and reply messages as described herein can be transmitted using any number of well-known communication and network protocols. They can include a packet, cell, message, or signal used to ask for and receive resources. Some examples include the HTTP communication protocol over a TCP/IP network protocol, HTTPS over SSL, FTP, etc.

Client devices 110 may generally include any type of device such as a personal computer, tablet, PDA, cell phone, or other processor-based computing device. The client devices may be mobile devices or non-mobile client devices may be used. Mobile devices include cellular telephones, palmtops, pocket computers, personal digital assistants, personal organizers, personal computers (PCs), and the like. Although described herein in combination with client devices 110, alternative embodiments can be used with any number of computer systems, such as desktop computers, other hand-held devices, laptop or notebook computer systems, multiprocessor systems, micro-processor based or programmable consumer electronics, network PCs, mini computers, main frame computers and the like.

Although databases are used for data storage in FIG. 1 other data storage techniques may be used. For example, the information may be maintained in flat files or other data structures, including unstructured schema-defined data. Embodiments may also be practiced in distributed computing environments where tasks are performed by remote processing devices that are linked through a communications network in a distributed computing environment, with programs located in both local and remote memory storage devices. Although specific components and software modules are depicted, it will be apparent that numerous physical and software based configurations may be employed while remaining within the spirit of the present disclosure. Generally, software and program modules as described herein include routines, programs, components, data structures, and other types of structures that perform particular tasks or implement particular abstract data types. Hardware or combinations of hardware and software can be substituted for software modules as described herein.

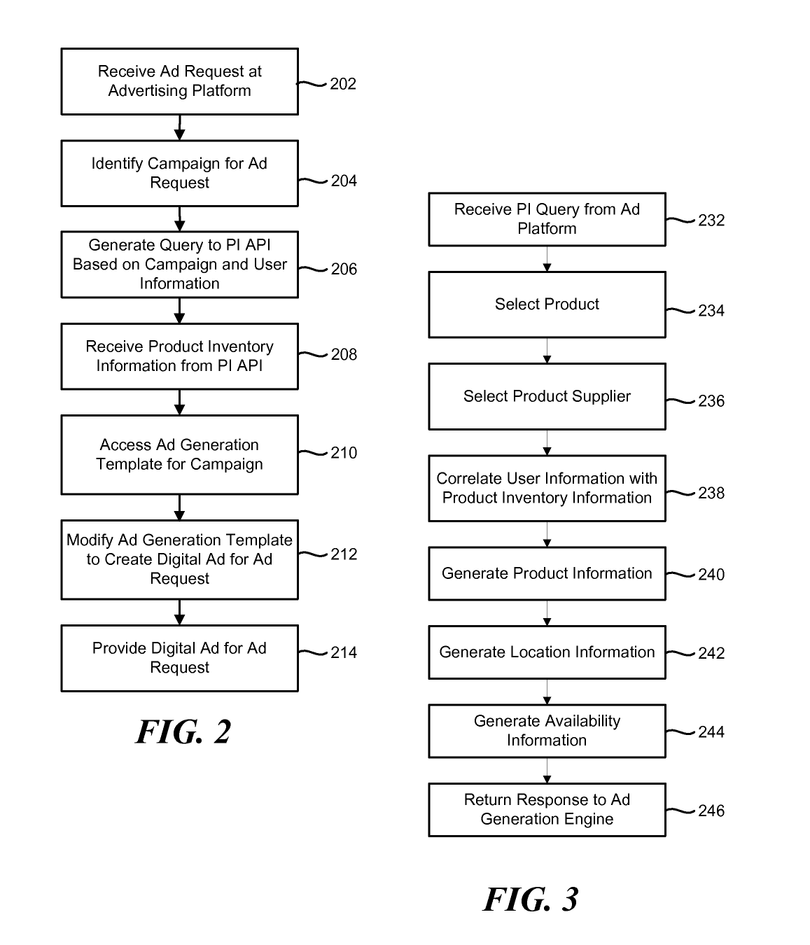

FIG. 2 is a flowchart describing processing by advertising platform 140 in one embodiment to dynamically create advertisements for individual ad requests. At step 202, the advertising platform receives an ad request, and accesses user information relating to the ad request. At step 204, the ad platform identifies an ad campaign corresponding to the ad request. In one example, the ad platform may publish advertising campaigns with an identifier. Publishers or other entities can submit the identifier to the ad platform with an ad request for the advertising campaign. In another example, the ad platform may select an advertising campaign after receiving the ad request, for example based on comparing the user information included in the ad request with various campaign information as described hereinafter.

At step 206, the ad platform generates a query to the PI platform 124 for product inventory information based on the advertising campaign and user information. The ad platform generates the query using one or more of the user information, product(s) associated with the advertising campaign, and advertiser or product supplier information for the campaign. In one embodiment, the ad platform passes the user information from the ad request directly to the PI platform. In other examples, the ad platform extracts portions of the user information, such as user location or other previously identified information for queries, to pass to the PI platform.

An advertising campaign may be associated with a specific product. An identification for the product can be maintained in the advertising campaign. The advertising platform can formulate the query at step 206 to include any product identifications included the advertising campaign. An advertising campaign may not be associated with a specific product or group of products, but instead be associated with a product supplier such as a retailer or product manufacturer. In this case, the advertising platform can formulate the query at step 206 to include an identification of one or more product suppliers associated with the advertising campaign. As described hereinafter, the PI platform can select store locations using a supplier identification as part of determining product inventory information, for example, to narrow results to the retailer or a group of retailers. Additionally, an advertising campaign may identify any combination of products or suppliers for narrowing product inventory result information.

In one example, an advertising campaign can be associated with a group of products. An advertising campaign can include an identification of the product group. In this case, the advertising platform can formulate the query at step 206 to include an identification of the product group. As described hereinafter, the PI platform can select products as part of determining product inventory information where the information is provided in a query from the ad platform.

At step 208, the ad platform receives product inventory information from the PI platform in response to the query generated at step 206. The product inventory information includes one or more of product information for the product(s) associated with the advertising campaign, location information for one or more stores, and availability information relating to inventory of the product(s) at the one or more stores. If the ad platform does not supply a product identification(s) in the query at step 206, the PI platform selects and returns information for one or more products based on the information supplied in the query. If one or more products are specified, the PI platform returns product inventory information for the specified product(s). The product inventory information is based on the user information so that the product, location, and availability are tailored to the particular user and ad request.

At step 210, the ad platform accesses one or more ad generation templates associated with the advertising campaign of the ad request. At step 212, the ad platform modifies the ad generation template using the product inventory information returned by the PI platform at step 208. The ad platform replaces one or more dynamic fields of the ad generation template with data from the product inventory information. By way of example, the ad platform can modify the ad generation template to include location information for a retail store associated with the product. The ad platform may modify the template to include product information related to the product, including for example, a picture, description, or price of the product provided by the PI platform and corresponding to the determined location information. Thus, the advertisement is generated in real-time for the individual ad request and the product inventory information identifies real-time inventory information for one or more products. At step 214, the ad platform provides the dynamically-generated ad in response to the ad request.

FIG. 3 is a flowchart describing processing by the PI platform in one embodiment to provide product inventory information in response to a query from ad platform 140, as may be generated and transmitted at step 206 of FIG. 2, for example. At step 232, the PI platform receives the query from the ad platform and at step 234, determines one or more products for the query. Step 234 may include selecting one or more products specified in the query or dynamically determining one or more products for the query. If one or more specific products are included in the query, the PI API will generate product inventory information for the specified products. If a product group is specified in the query, the PI engine can select one of the products in the group. In one embodiment, product rules specified for the corresponding campaign are used to select a product from the group. Similarly, if no product or product grouping is specified, the PI engine may dynamically select a product using one or more product rules.

Product rules can be specified in an advertising campaign 152 as set forth hereinafter. The product rules can be accessible to PI Engine 126, for example by replication to the PI platform or sharing data between platforms. In one embodiment, the PI Engine implements the product rules. Numerous types of product rules may be specified. An advertising campaign 152 can specify that the PI engine select a product based on the time of day, the weather, or based on user information submitted with the query. In one example, the product rules may specify cycling through products in a group. The product rules may include any types of instructions for programming PI Engine 126 to select products. In one specific non-limiting example, the PI API may select a product based on temperature or other factors in the weather such as cloud cover, precipitation, etc. An advertising campaign may specify any number or type of rules for selecting a product by the PI platform.

At step 236, the PI platform optionally determines one or more product suppliers associated with the query. A product supplier may be identified directly in the query or the PI platform may dynamically determine the product supplier. In one example, an identification of a group of product suppliers such as a group of retailers can be included in the query and the PI platform can dynamically determine one or more product suppliers. The PI platform may determine the product supplier using one or more supplier rules in a corresponding campaign 152. Similar to product grouping, when no product supplier is specified the PI platform can apply supplier rules to select a product supplier. In another example, a campaign may not specify supplier rules. A supplier can be selected as part of determining product inventory information. The system may include all suppliers, for example, in determining product inventory information for an ad request.

At step 238, the PI platform correlates the user information for the ad request with product inventory information. Step 238 may take many different forms. In one example, step 238 includes using location data in the user information. For example, the system may determine a store location near or nearest to the user with an available inventory of a product for the advertising campaign. Different search techniques may be used. If a retailer group is specified in the ad campaign, step 238 may include techniques for selecting a retailer. Distance from the user to the store locations for all retailers in the group can be used. Various campaign rules may also be applied to cycle through retailers, for example.

After selecting a product and correlating the user information with product inventory information, the system generates product information for the query at step 240. In one example, the PI platform returns product information from database 122 that corresponds to one or more store locations from step 238 and one or more products from step 234. Step 240 can include returning a product description, product image or URL for a product image, and product price, for example. Other product information can be returned. At step 242, the PI platform returns the location information from database 122 for the store location determined at step 238. In one embodiment, the PI platform determines the distance from the user to the store location determined at step 238 and returns the distance as part of the location information. At step 244, the PI platform returns the availability information for the product(s) from step 236. Step 244 can include returning a number of the items available at the one or more selected store locations. Step 244 can include an in-stock notification in another example. In one example, the system indicates an in-stock date for an out-of-stock item. At step 246, the PI platform returns a response to the ad generation platform including the product, location and availability information. In one embodiment, the PI API generates an XML document or file containing the product, location, and/or availability information.

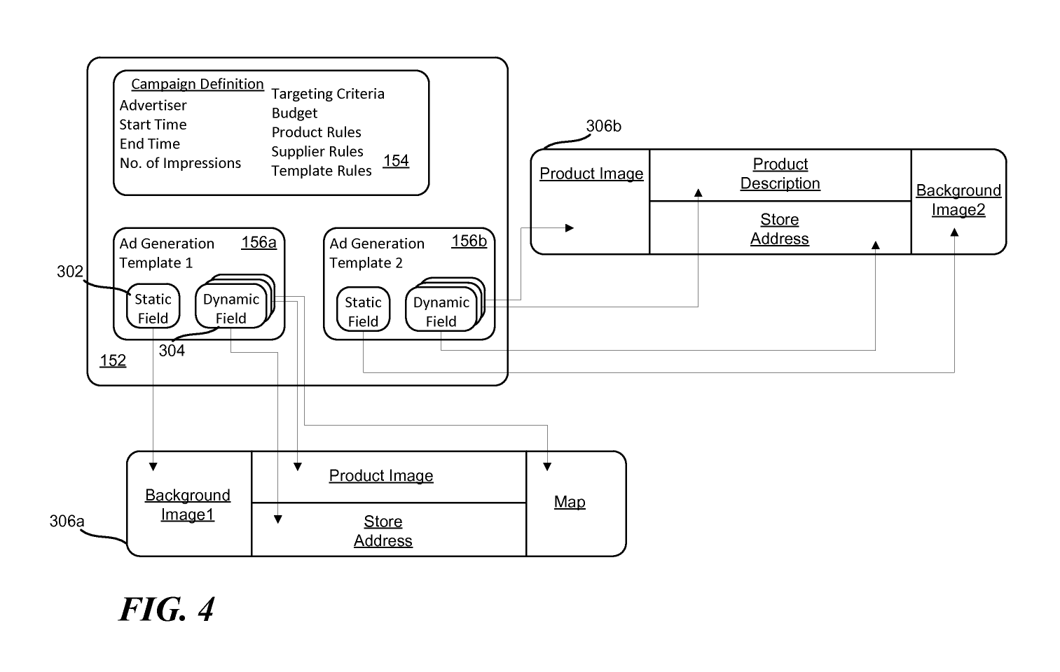

FIG. 4 is a simplified block diagram describing an example of an advertising campaign 152 as can be stored in database 150 in one embodiment. Advertising campaign 152 includes a campaign definition 154 and two ad generation templates 156a and 156b. Two ad generation templates are provided as an example. A campaign may include any number of generation templates 156 to generate different advertisements for the same campaign.

Campaign definition 154 specifies a range of criteria or attributes for the advertising campaign. Information such as an identification of the advertiser, timing for the advertising campaign, number of impressions to be shown, budget, and targeting criteria can be included. If the advertising campaign is associated with a product or a number of products, the product(s) can be identified in the campaign definition. If the campaign is associated with a group of products, an identification of the product group can be included. Other attributes and criteria or less than all of the attributes and criteria shown may be included in other examples.

The campaign definition can also specify product rules for determining which of a number of products to use for a particular ad request. A supplier such as a retailer or manufacturer may wish to have multiple products shown for a single advertising campaign. The product rules can specify how a product(s) is to be determined for each ad request. The product rules can be used by the ad platform or the PI platform to select products for ad requests. Although shown as part of the campaign definition at the ad platform, product rules may be stored or implemented at the PI platform, in addition to or in place of the product rules at the ad platform. In one example, the PI engine implements product rules specified in the campaign.

The campaign definition can also specify supplier rules for determining a supplier for each ad request for an advertising campaign. A product supplier such as a manufacturer may specify an advertising campaign to show product inventory information for multiple retailers, such as by using a supplier or retailer grouping designation for example. The supplier rules may specify how the ad platform or PI platform is to select a supplier from the group for each ad request. Like the product rules, the supplier rules may be implemented at the PI platform in place of or in addition to the ad platform.

Two ad generation templates 156a and 156b are associated with advertising campaign 152 in FIG. 4. Template rules in the campaign definition may specify how the ad generation templates are selected. Interaction with different templates may also be tracked or other metrics determined to dynamically decide which template to use. Different templates may also be selected based on user information and targeting criteria or demographic data specified in the data campaign. Different templates may also be associated with the same advertising campaign corresponding to different client devices to meet the requirements of different operating environments.

Each ad generation template 156 includes one or more static fields 302 and one or more dynamic fields 304. The static fields are elements that remain the same for each ad that is generated using the template. The dynamic fields, however, are elements that change for each ad generated using the template. In FIG. 4, both ad generation templates include one static field 302 and three dynamic fields 304. FIG. 4 also depicts an example of banner advertisements 306a and 306b that can be generated using ad generation template 156a and 156b. As shown in ad generation template 156a, the static field 302 maps to or specifies a locator for a background image, Background Image1, at a left portion of the banner ad. A first dynamic field maps to a store address at a lower center portion of the banner ad, a second dynamic field maps to a product image at an upper center portion of the banner ad, and a third dynamic field maps to a map of the store location at a left portion of the banner ad. For ad generation template 156b, the static filed maps to a background image, Background Image2, at a right portion of the banner ad. A first dynamic field 304 maps to a store address at a lower center portion of the banner ad, a second dynamic field maps to a product description at an upper center portion of the banner ad, and a third dynamic field maps to a product image at a left portion of the banner ad. It will be appreciated that the template demonstrated in FIG. 4 is provided by way of example and not limitation, and that different templates having any number of static and dynamic fields may be used. An ad generation template may include a default document or file used to produce an ad in based on product inventory modifications. In another embodiment, an ad generation template may include instructions for dynamically generating an ad based on a particular ad request.

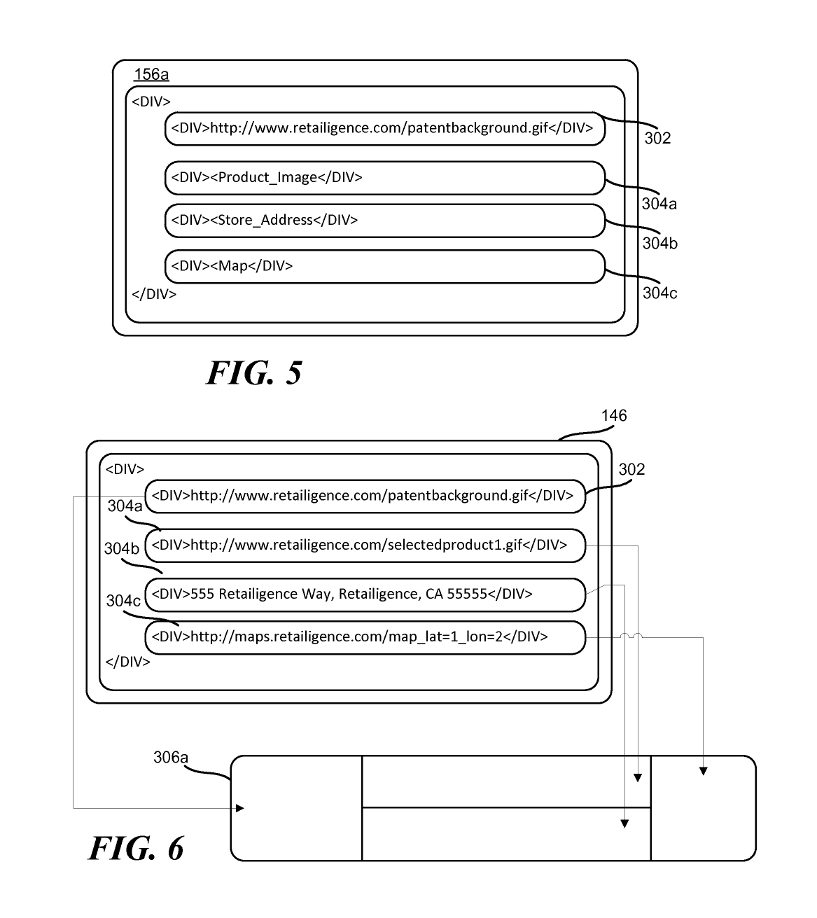

FIG. 5 is a simplified block diagram depicting an example of an ad generation template in one embodiment. In this particular example, the template corresponds to the ad generation template 1 156a in FIG. 4. The template is implemented as an HTML file, having static portions that are not changed when a digital advertisement is generated using the template and dynamic portions that are changed by the ad generation engine for each digital advertisement generated using the template. Static field 302 of the template is specified by a uniform resource locator (URL) for a background image file. The first dynamic field 304a contains a description “Product Image” as a placeholder for a product image that is dynamically determined for each ad request. The second dynamic field 304b contains a description “Store Address” as a placeholder for a store address that is dynamically determined for each ad request. The third dynamic field 304c contains a description “Map” as a placeholder for a map tile that is dynamically determined for each ad request.

FIG. 6 is a simplified block diagram depicting an example of one digital advertisement that can be generated from the ad generation template 156a of FIG. 5. The ad generation engine requests and receives from the PI platform product inventory information for a particular ad request. The product inventory information is used to modify one or more dynamic portions 304 of the ad generation template for generating an individual ad. In this example, the PI platform returns product inventory information specifying a URL for an image of the product associated with the ad request to complete the first dynamic filed 304a. The ad platform replaces the placeholder description for the first dynamic field with the URL for the product image returned by the PI platform. The PI platform further returns text with the address of the store location to complete the second dynamic field 304b. The ad platform replaces the placeholder description with the text of the store address in the product inventory information. The PI platform returns product inventory information specifying a URL to a map of the store location determined for the ad request to complete the third dynamic field 304c. The ad platform replaces the placeholder description with the URL of the map of the store location. The ad generation engine may also add text to depict a product description or other information directly from an XML or other response by the PI platform. Although FIGS. 5 and 6 depict an HTML file template to generate a banner style ad, the described techniques are readily extensible to the use of other templates to generate any number and style of ad.

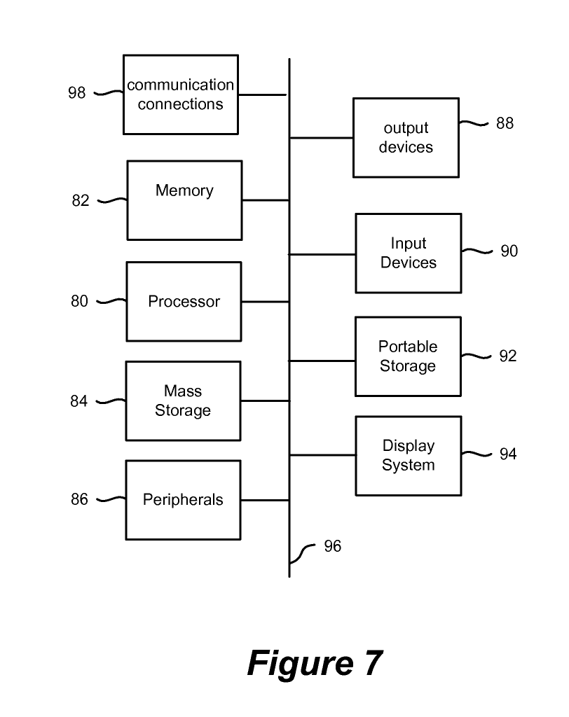

FIG. 7 is a high level block diagram of a computing system which can be used to implement any of the computing devices of FIG. 1. The computing system of FIG. 7 includes processor 80, memory 82, mass storage device 84, peripherals 86, output devices 88, input devices 90, portable storage 92, and display system 94. For purposes of simplicity, the components shown in FIG. 7 are depicted as being connected via a single bus 96. However, the components may be connected through one or more data transport means. In one alternative, processor 80 and memory 82 may be connected via a local microprocessor bus, and the mass storage device 84, peripheral device 86, portable storage 92 and display system 94 may be connected via one or more input/output buses.

Processor 80 may contain a single microprocessor, or may contain a plurality of microprocessors for configuring the computer system as a multiprocessor system. Memory 82 stores instructions and data for programming processor 80 to implement the technology described herein. In one embodiment, memory 82 may include banks of dynamic random access memory, high speed cache memory, flash memory, other nonvolatile memory, and/or other storage elements. Mass storage device 84, which may be implemented with a magnetic disc drive or optical disc drive, is a nonvolatile storage device for storing data and code. In one embodiment, mass storage device 84 stores the system software that programs processor 80 to implement the technology described herein. Portable storage device 92 operates in conjunction with a portable nonvolatile storage medium, such as a floppy disc, CD-RW, flash memory card/drive, etc., to input and output data and code to and from the computing system of FIG. 7. In one embodiment, system software for implementing embodiments is stored on such a portable medium, and is input to the computer system via portable storage medium drive 92.

Peripheral devices 86 may include any type of computer support device, such as an input/output interface, to add additional functionality to the computer system. For example, peripheral devices 86 may include one or more network interfaces for connecting the computer system to one or more networks, a modem, a router, a wireless communication device, etc. Input devices 90 provide a portion of a user interface, and may include a keyboard or pointing device (e.g. mouse, track ball, etc.). In order to display textual and graphical information, the computing system of FIG. 7 will (optionally) have an output display system 94, which may include a video card and monitor. Output devices 88 can include speakers, printers, network interfaces, etc. Device 100 may also contain communications connection(s) 112 that allow the device to communicate with other devices via a wired or wireless network. Examples of communications connections include network cards for LAN connections, wireless networking cards, modems, etc. The communication connection(s) can include hardware and/or software that enables communication using such protocols as DNS, TCP/IP, UDP/IP, and HTTP/HTTPS, among others.

The components depicted in the computing system of FIG. 7 are those typically found in computing systems suitable for use with the technology described herein, and are intended to represent a broad category of such computer components that are well known in the art. Many different bus configurations, network platforms, operating systems can be used. The technology described herein is not limited to any particular computing system.

The technology described herein, including the advertising platform and product inventory platform can be implemented using hardware, software, or a combination of both hardware and software. The software used is stored on one or more of the processor readable storage devices described above (e.g., memory 82, mass storage 84 or portable storage 92) to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware including custom integrated circuits, gate arrays, FPGAs, PLDs, and special purpose computers. In one embodiment, software (stored on a storage device) implementing one or more embodiments is used to program one or more processors. The one or more processors can be in communication with one or more computer readable media/storage devices, peripherals and/or communication interfaces. In alternative embodiments, some or all of the software can be replaced by dedicated hardware including custom integrated circuits, gate arrays, FPGAs, PLDs, and special purpose computers.

The foregoing detailed description has been presented for purposes of illustration and description. It is not intended to be exhaustive or to limit the invention to the precise form disclosed. Many modifications and variations are possible in light of the above teachings. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A computer-implemented method of serving digital advertisements, comprising:
receiving over one or more computer a networks a plurality of ad requests;
for each ad request, determining product inventory information based on user information associated with the ad request; and
modifying at least one ad generation template to generate a digital advertisement for each ad request, the digital advertisement for each ad request including product inventory information based on the user information associated with the ad request.

2. A computer-implemented method according to claim 1, wherein the plurality of ad requests are associated with a plurality of advertising campaigns and the plurality of advertising campaigns are each associated with one or more of a plurality of ad generation templates.

3. A computer-implemented method according to claim 2, wherein the user information for each ad request includes location information and determining product inventory information includes:
determining a set of store locations having an availability of one or more products associated with the ad request and location information for each store location of the set;
comparing the location information for each store location of the set to the location information associated with the ad request; and
selecting the product inventory information from one or more store locations of the set based on comparing the location information for each store location to the location information associated with the ad request.

4. A computer-implemented method according to claim 3, wherein modifying at least one ad generation template, comprises:
in response to a first ad request associated with a first advertising campaign and having first user location information, generating a first digital advertisement by modifying a first ad generation template to include location information for a first store based on the first user location information and the location information for the first store; and
in response to a second ad request associated with the first advertising campaign and having second user location information, generating a second digital advertisement by modifying the first ad generation template to include location information for a second store based on the second user location information and the location information for the second store;

5. A computer-implemented method according to claim 2, further comprising:
modifying a first ad generation template in response to a first ad request associated with a first advertising campaign; and
modifying a second ad generation template in response to a second ad request associated with a second advertising campaign.

6. A computer-implemented method according to claim 2, further comprising:
modifying a third ad generation template in response to a third ad request associated with the first advertising campaign.

7. A computer readable storage medium having computer readable instructions for programming a processor to perform a method of serving digital advertisements, the method comprising:
storing a plurality of digital advertising campaigns, each digital advertising campaign including an ad generation template and a campaign definition, each ad generation template including at least one dynamically modifiable field;
receiving a plurality of advertisement requests associated with the plurality of digital ad campaigns;
accessing user information associated with each advertisement request;
determining product inventory information in response to each advertisement request based on the user information for the advertisement request; and
generating a digital advertisement for each advertisement request by modifying the at least one dynamically modifiable field of the ad generation template for the corresponding digital campaign based on the product inventory information determined for the advertisement request.

8. A computer readable storage medium according to claim 7, wherein:
determining product inventory information for each advertisement request includes selecting a product based on the user information.

9. A computer readable storage medium according to claim 8, wherein:
selecting a product based on the user information includes determining product availability information for one or more products at one or more retail locations determined from location data in the user information.

10. A computer readable storage medium according to claim 7, wherein:
determining product inventory information for each ad request includes selecting a first product when the user information indicates a first user location and selecting a second product when the user information indicates a second user location.

11. A computer readable storage medium according to claim 7, wherein:
determining product inventory information for each ad request includes selecting a product based on weather information.

12. A computer readable storage medium according to claim 7, wherein:
a first advertising campaign specifies one or more products to be displayed for each digital advertisement generated for the first advertising campaign; and
determining product inventory information in response to each advertisement request for the first advertising campaign includes selecting a retailer and one or more retail locations associated with the retailer based on the user information for the advertisement request and product availability information for the one or more products.

13. A computer readable storage medium according to claim 12, wherein:
the user information for each advertisement request includes location information for a user associated with the request; and
determining product inventory information in response to each advertisement request for the first advertising campaign includes selecting the one or more retail locations based on product availability information for the one or more products and a distance of the user from the one or more retail locations.

14. A computer readable storage medium according to claim 7, wherein:
the user information associated with each advertisement request is included with the corresponding ad request.

15. An advertising system, comprising:
one or more first storage devices storing product inventory information for a plurality of product suppliers, each product supplier is associated with a plurality of store locations, the information for each product supplier including product information and availability information for a plurality of products at the plurality of store locations;
one or more first processors in communication with the one or more first storage devices, the one or more first processors receive a plurality of requests for product inventory information and based on user information for each request generate a response with product inventory information;
one or more second storage devices storing a plurality of advertising campaigns, each advertising campaign is associated with at least one ad generation template having one or more dynamic fields for replacement to generate digital advertisements; and
one or more second processors in communication with the one or more second storage devices that receive a plurality of ad requests including user information associated with each ad request, wherein for each ad request the one or more second processors determine an ad campaign and generate a request to the one or more first processors for product inventory information associated with the ad campaign based on the user information of the ad request, the one or more second processors receive a response from the one or more first processors for each request and dynamically generate a digital advertisement for the request by modifying the at least one ad generation template for the corresponding advertising campaign based on the product inventory information.
